(19) United States
(12) Patent Application Publication
(10) Pub. No.: US 2025/0029087 A1
(43) Pub. Date: Jan. 23, 2025

(54) SYSTEMS AND METHODS FOR EPHEMERAL VCN PROVISIONING

(71) Applicant: Capital One Services, LLC, McLean, VA (US)

(72) Inventors: Jeffrey RULE, Chevy Chase, MD (US); Bob Uni KOSHY, Henrico, VA (US); Cory CHASE, Richmond, VA (US); Derek SHI, McLean, VA (US)

(21) Appl. No.: 18/224,264

(22) Filed: Jul. 20, 2023

(51) Int. Cl. G06Q 20/22; G06Q 20/10; G06Q 20/34; G06Q 20/38; G06Q 20/40

(52) U.S. Cl. CPC G06Q 20/227; G06Q 20/108; G06Q 20/351; G06Q 20/3821; G06Q 20/4014; G06Q 20/4016; G06Q 2220/00

(57) ABSTRACT

Example embodiments disclose systems and methods for provisioning a virtual card number (VCN) directly to the merchant processor responsible for a consumer transaction. The VCN can be restricted according to one or more restrictions and in some embodiments, a predictive model can generate the one or more restrictions.

### FIELD OF THE DISCLOSURE

The present disclosure relates to systems and methods for provisioning of a virtual card number (VCN) without sharing the VCN to the user.

### BACKGROUND

Virtual card numbers (VCNs) are often used in consumer transactions. VCNs are useful because they add an additional layer of security, particularly for online transactions. By using a virtual card number, customers can prevent their actual credit or debit card information from being exposed to hackers, fraudsters, or other malicious actors.

However, VCNs are still at risk of fraud and privacy breaches by nefarious third parties. Conventional systems and methods allow only for VCNs to be transmitted to the merchant through the user, thus exposing the VCN to a greater risk of fraud.

These and other deficiencies exist. Therefore, there is a need to provide systems and methods for provisioning VCNs that overcome these deficiencies.

### SUMMARY OF THE DISCLOSURE

Aspects of the disclosed embodiments include systems and methods for generating a VCN and a sharing the VCN directly to a merchant processor.

In some aspects, the techniques described herein relate to a system for generating a VCN, the system including: a server including a banking application, wherein the banking application is configured to: receive, from a user device application, one or more user identification data; match the one or more user identification data to a user profile; transmit, to the user device application, an authentication request; receive, from the user device application an authentication credential; retrieve, one or more primary account numbers (PANs) associated with the user profile; transmit, to the user device application, a prompt to choose one or more of the PANs with which to complete a transaction; receive, from the user device application, a choice of one or more PANs; generate a VCN associated with the chosen one or more PANs; and transmit the VCN to a merchant processor.

In some aspects, the techniques described herein relate to a method for generating a VCN, the method including the steps of: receiving, by a banking application associated with a server, one or more user identification data; matching, by the banking application, the one or more user identification data to a user profile; transmitting, by the banking application to a user device application, an authentication request; receiving, by the banking application from the user device application, an authentication credential; retrieving, one or more PANs associated with the user profile; transmitting, to the user device application, a prompt to choose one or more of the PANs with which to complete a transaction; receiving, from the user device application, a choice of one or more PANs; generating, by the banking application, a VCN associated with the chosen one or more PANs; and transmitting, by the banking application, the VCN to a merchant processor.

In some aspects, the techniques described herein relate to a computer readable non-transitory medium including computer executable instructions that, when executed by a computer hardware arrangement including a processor, causes the computer hardware arrangement to perform procedures including: receiving one or more user identification data; matching the one or more user identification data to a user profile; transmitting to a user device application, an authentication request; receiving, from the user device application, an authentication credential; retrieving, one or more PANs associated with the user profile; transmitting, to the user device application, a prompt to choose one or more of the PANs with which to complete a transaction; receiving, from the user device application, a choice of one or more PANs; generating, a VCN associated with the chosen one or more PANs; and transmitting the VCN to a merchant processor.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates a system according to an exemplary embodiment.

FIG. 2 illustrates a card according to an exemplary embodiment.

FIG. 3 illustrates a contact pad of a card according to an exemplary embodiment.

FIG. 4 illustrates a virtual card number restriction according to an exemplary embodiment.

FIG. 5 illustrates a method according to an exemplary embodiment.

FIG. 6 illustrates a method according to an exemplary embodiment.

FIG. 7 illustrates a method according to an exemplary embodiment.

FIG. 8 illustrates a method according to an exemplary embodiment.

FIG. 9 illustrates a method according to an exemplary embodiment.

FIG. 10 illustrates a neural network according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment and that the features, advantages, and characteristics of any example embodiment can be interchangeably combined with the features, advantages, and characteristics of any other embodiment. Additional features and advantages will be recognized in certain embodiments that may not be present in all embodiments.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

If the customer generates the VCN themselves or is able to see it, there is a higher risk of fraud. For example, the customer may inadvertently disclose the VCN through a phishing scam, or it may be stolen in a data breach. Additionally, if the customer generates the VCN, they may be more likely to reuse the same VCN for multiple transactions, which increases the risk of fraud if the VCN is compromised. Moreover, if the customer sees the VCN, they may be more likely to write it down or take a screenshot of it for future reference. This could make the VCN more vulnerable to theft, especially if the customer stores it in an unsecured location.

As a solution to this problem, the present disclosure explains how a VCN can be generated and transmitted directly to the merchant processor responsible for completing a transaction. Sending the VCN directly to the merchant for processing, rather than through the customer, can provide several additional advantages. Firstly, it eliminates the risk of the customer accidentally or intentionally sharing the VCN with unauthorized parties. This can significantly reduce the risk of fraud and unauthorized transactions. Secondly, it can also simplify the payment process for the customer, as they do not need to manually enter the VCN during the checkout process. This can make the payment process faster and more convenient, which can lead to a better customer experience. Thirdly, sending the VCN directly to the merchant for processing can help to reduce the risk of errors during the payment process. If the customer enters the VCN incorrectly or makes a mistake when inputting other payment details, it can cause delays or errors in processing the payment. By eliminating the need for the customer to enter the VCN, this risk is mitigated. Overall, sending the VCN directly to the merchant for processing provides a more streamlined and secure payment experience for the customer, while also reducing the risk of fraud and payment errors.

Furthermore, limiting the VCN to a certain set of merchant categories, such as grocery shopping and gas, can provide several advantages. Firstly, it can help to reduce the risk of unauthorized transactions. Since the VCN is limited to specific merchant categories, it cannot be used for purchases at other types of merchants. This can help to prevent fraudsters from using the VCN for unauthorized purchases, which can reduce the risk of chargebacks and other payment disputes. Secondly, it can help to simplify the tracking and management of the VCN. By limiting the VCN to specific merchant categories, it becomes easier to track and manage the transactions made with the VCN. This can help to simplify the reconciliation process and reduce the risk of errors. Overall, limiting the VCN to a certain set of merchant categories can provide increased security, simplify transaction management, and enhance customer confidence in the payment system.

Additionally, the benefit of using a predictive model or neural network to determine how the VCN should be restricted is that it can provide a more accurate and efficient way of detecting and preventing fraud, while still allowing legitimate transactions to go through. By analyzing past transaction data and learning patterns of legitimate transactions, a predictive model or neural network can determine the most effective restrictions for the VCN based on factors such as merchant categories, transaction amounts, and locations. This can help to prevent fraudulent transactions, as any transaction that falls outside of the established patterns or restrictions can be flagged for further review or declined outright. Furthermore, a predictive model or neural network can adapt to new patterns and trends in real-time, allowing it to adjust the restrictions for the VCN as needed to stay ahead of evolving fraud techniques. This can be especially important in today's constantly evolving digital landscape, where fraudsters are always looking for new ways to exploit vulnerabilities in payment systems.

Finally, sending the VCN directly to the merchant can help preserve network bandwidth. This is because sending the VCN to the customer first, and then having the customer submit it to the merchant, requires additional network traffic and data transfers. By eliminating this additional step, the process becomes more efficient and reduces network congestion, which can result in faster transaction times and lower costs for all parties involved.

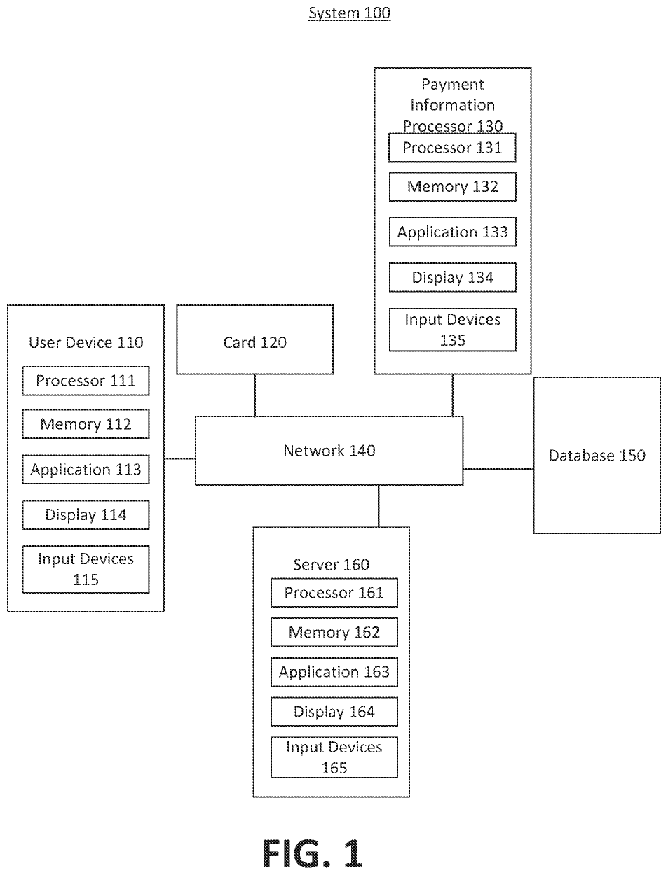

FIG. 1 illustrates FIG. 1 illustrates a system 100 according to an exemplary embodiment. The system 100 may comprise a user device 110, a card 120, a payment information processor 130, a network 140, a database 150, and a server 160. Although FIG. 1 illustrates single instances of components of system 100, system 100 may include any number of components.

System 100 may include a user device 110. The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a card (e.g., a contactless card, a contact-based card), an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. A wearable smart device can include without limitation a smart watch.

The user device 110 may include a processor 111, a memory 112, and an application 113. The processor 111 may be a processor, a microprocessor, or other processor, and the user device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 110 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's private data and financial account information.

The application 113 may comprise one or more software applications, such as a mobile application and a web browser, comprising instructions for execution on the user device 110. In some examples, the user device 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described below. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touch-screen, keyboard, mouse, cursor-control device, touch-screen, microphone, digital camera, video recorder or camcorder. These devices may be used to enter information and interact with the software and other devices described herein.

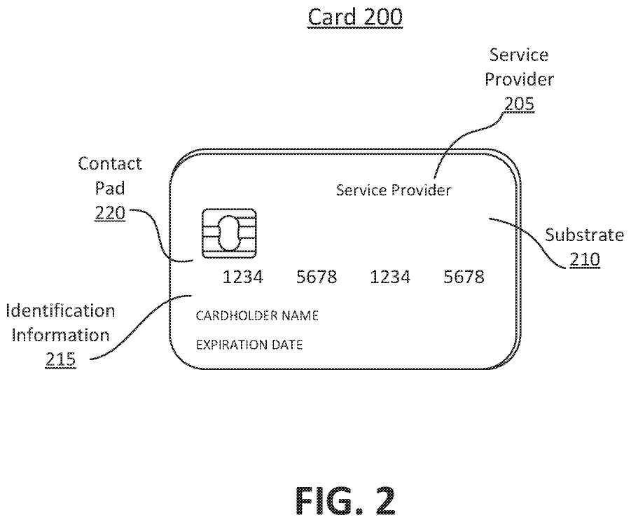

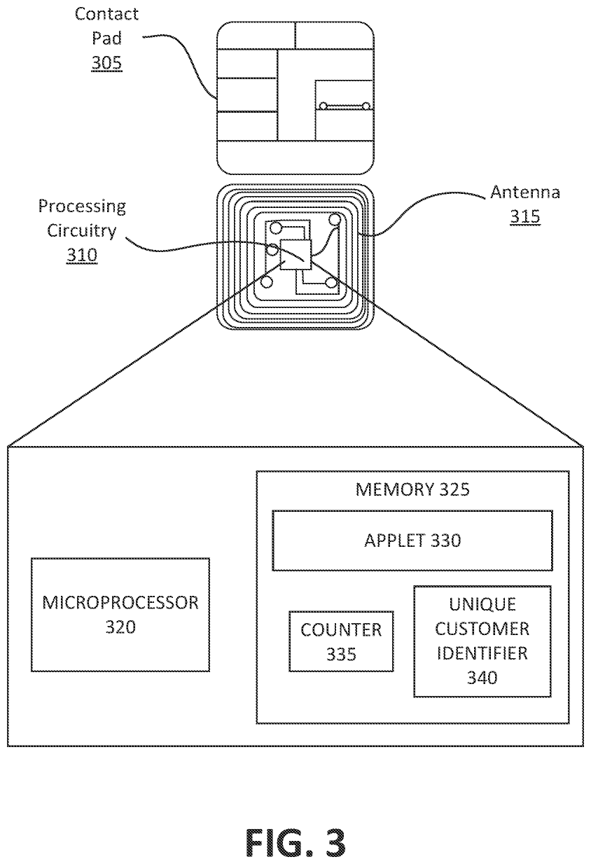

System 100 may include one or more cards 120 which are further explained below with reference to FIG. 2 and FIG. 3. In some embodiments, card 120 may be in wireless communication, utilizing NFC in an example, with user device 110.

System 100 may include a payment information processor 130. The payment information processor 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a card (e.g., a contactless card, a contact-based card), an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The payment information processor 130 may include a processor 131, a memory 132, and an application 133. The processor 131 may be a processor, a microprocessor, or other processor, and the payment information processor 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the payment information processor 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's private data and financial account information.

The application 133 may comprise one or more software applications comprising instructions for execution on the payment information processor 130. In some examples, the payment information processor 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The payment information processor 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the payment information processor 130 that can be available and supported by the payment information processor 130, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network, and may be configured to connect the user device 110, the card 120, the payment information processor 130, the database 150 and the server 160. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 160 or may be hosted externally of the server 160, such as by a server, by a cloud-based platform, or in any storage device that is in data communication with the server 160.

The server 160 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a card (e.g., a contactless card, a contact-based card), an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 160 may include a processor 161, a memory 162, and an application 163. The processor 161 may be a processor, a microprocessor, or other processor, and the server 160 may include one or more of these processors. The server 160 can be onsite, offsite, standalone, networked, online, or offline.

The processor 161 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 161 may be coupled to the memory 162. The memory 162 may be a read-only memory, write-once read-multiple memory or read/write memory, e.g., RAM, ROM, and EEPROM, and the server 160 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 162 may be configured to store one or more software applications, such as the application 163, and other data, such as user's private data and financial account information.

The application 163 may comprise one or more software applications comprising instructions for execution on the server 160. In some examples, the server 160 may execute one or more applications, such as software applications, that enable, for example, network communications with one or more components of the system 100, transmit and/or receive data, and perform the functions described herein. Upon execution by the processor 161, the application 163 may provide the functions described in this specification, specifically to execute and perform the steps and functions in the process flows described below. Such processes may be implemented in software, such as software modules, for execution by computers or other machines. The application 163 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 160 may further include a display 164 and input devices 165. The display 164 may be any type of device for presenting visual information such as a computer monitor, a flat panel display, and a mobile device screen, including liquid crystal displays, light-emitting diode displays, plasma panels, and cathode ray tube displays. The input devices 165 may include any device for entering information into the payment information processor 130 that is available and supported by the payment information processor 130, such as a touch-screen, keyboard, mouse, cursor-control device, touch-screen, microphone, digital camera, video recorder or camcorder. These devices may be used to enter information and interact with the software and other devices described herein.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the user device 110, the card 120, the payment information processor 130, the network 140, the database 150, and the server 160 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

FIG. 2 illustrates a card 200 according to an exemplary embodiment. The card 200 may comprise a payment card, such as a credit card, debit card, or gift card, issued by a service provider 205 displayed on the front or back of the card 200. In some examples, the payment card may comprise a dual interface contactless payment card. In some examples, the card 200 is not related to a payment card, and may comprise, without limitation, an identification card, a membership card, a loyalty card, a transportation card, and a point of access card.

The card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the card 200 may have physical characteristics compliant with the ID-1 format of the ISO/IEC 7810 standard, and the card may otherwise be compliant with the ISO/IEC 14443 standard. However, it is understood that the card 200 according to the present disclosure may have different characteristics, and the present disclosure does not require a card to be implemented in a payment card.

The card 200 may also include identification information 215 displayed on the front and/or back of the card, and a contact pad 220. The contact pad 220 may be configured to establish contact with another communication device, such as a user device, smart phone, laptop, desktop, smart watch, some other wearable device, or tablet computer. The card 200 may also include processing circuitry, antenna and other components not shown in FIG. 2. These components may be located behind the contact pad 220 or elsewhere on the substrate 210. The card 200 may also include a magnetic strip or tape, which may be located on the back of the card (not shown in FIG. 2).

FIG. 3 illustrates a contact pad of a card according to an exemplary embodiment.

As illustrated in FIG. 3, the contact pad 305 may include processing circuitry 310 for storing and processing information, including a microprocessor 320 and a memory 325. It is understood that the processing circuitry 310 may contain additional components, including processors, memories, error and parity/CRC checkers, data encoders, anticollision algorithms, controllers, command decoders, security primitives and tamperproofing hardware, as necessary to perform the functions described herein.

The memory 325 may be a read-only memory, write-once read-multiple memory or read/write memory, e.g., RAM, ROM, and EEPROM, and the card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 325 may be configured to store one or more applets 330, one or more counters 335, and a customer identifier 340. The one or more applets 330 may comprise one or more software applications configured to execute on one or more cards, such as Java Card applet. However, it is understood that applets 330 are not limited to Java Card applets, and instead may be any software application operable on cards or other devices having limited memory. The one or more counters 335 may comprise a numeric counter sufficient to store an integer. The customer identifier 340 may comprise a unique alphanumeric identifier assigned to a user of the card 200, and the identifier may distinguish the user of the card from other card users. In some examples, the customer identifier 340 may identify both a customer and an account assigned to that customer and may further identify the card associated with the customer's account.

The processor and memory elements of the foregoing exemplary embodiments are described with reference to the contact pad, but the present disclosure is not limited thereto. It is understood that these elements may be implemented outside of the pad 305 or entirely separate from it, or as further elements in addition to processor 320 and memory 325 elements located within the contact pad 305.

In some examples, the card 200 may comprise one or more antennas 315. The one or more antennas 315 may be placed within the card 200 and around the processing circuitry 310 of the contact pad 305. For example, the one or more antennas 315 may be integral with the processing circuitry 310 and the one or more antennas 315 may be used with an external booster coil. As another example, the one or more antennas 315 may be external to the contact pad 305 and the processing circuitry 310.

In an embodiment, the coil of card 200 may act as the secondary of an air core transformer. The terminal may communicate with the card 200 by cutting power or amplitude modulation. The card 200 may infer the data transmitted from the terminal using the gaps in the card's power connection, which may be functionally maintained through one or more capacitors. The card 200 may communicate back by switching a load on the card's coil or load modulation. Load modulation may be detected in the terminal's coil through interference.

As explained above, the cards 200 may be built on a software platform operable on smart cards or other devices having limited memory, such as JavaCard, and one or more or more applications or applets may be securely executed. Applets may be added to cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

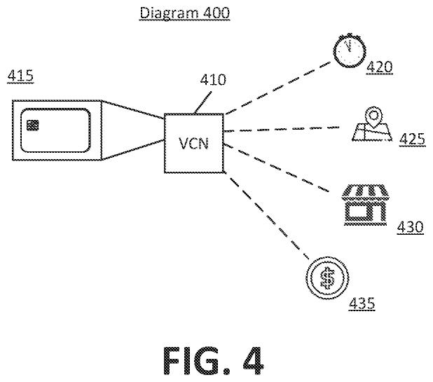

FIG. 4 illustrates virtual payments cards or virtual payment numbers. Virtual payment cards are unique payment cards that allow users to complete transactions on their main payment card account associated with one or more of their financial accounts. In some examples, virtual payments cards can be limited to one-time use. In other examples, virtual payment cards can be limited to a predetermined number of uses and/or an unlimited number of uses over a predetermined time period. It is understood that virtual payment cards can have other characteristics and features as described herein.

Diagram 400 illustrates an example of a virtual payment card. The virtual payment card may be generated by a third-party mobile application or banking application. The virtual payment card may be sent over a wired or wireless network. The virtual card may contain the information present on a physical card 415 discussed in FIG. 2 and FIG. 3.

To protect the user's information, the virtual payment card may come with limitations. In element 420, the card may be limited by time. The virtual payment card may expire after a certain amount of time, for example fifteen minutes. It is understood that the amount of time can be lengthened or shortened greatly. In element 425, the virtual payment card may be limited by geography. The virtual payment card may expire if the user device leaves a predetermined geographical area. This predetermined area can be decided by the administrator processing system, the account processing system, or the users themselves. The geographical area can vary considerably. For example, the virtual card may be limited to a small area around a particular storefront.

In element 430, the virtual payment card may be limited by vendor to only one or more vendors. For example, a card may be limited to only one unique vendor in a unique location. Alternatively, the virtual card may be limited to vendors in a designated area such as a mall, market, or flea market. In another example, the virtual card may be limited to an entire franchise—that is, the card may be used at any store that is associated with a specific franchise. In element 435, the virtual payment card may be limited by the amount of money available on the card. The card may be capped at a certain amount, for example $100. This amount can vary considerably. This amount can be determined by the user, the administrator processing system, or the account processing system. It is understood that a virtual payment card may combine these one or more limitations. The limits and security features listed above may be increased, decreased, or otherwise changed. These changes can be implemented by the user or the banking processor.

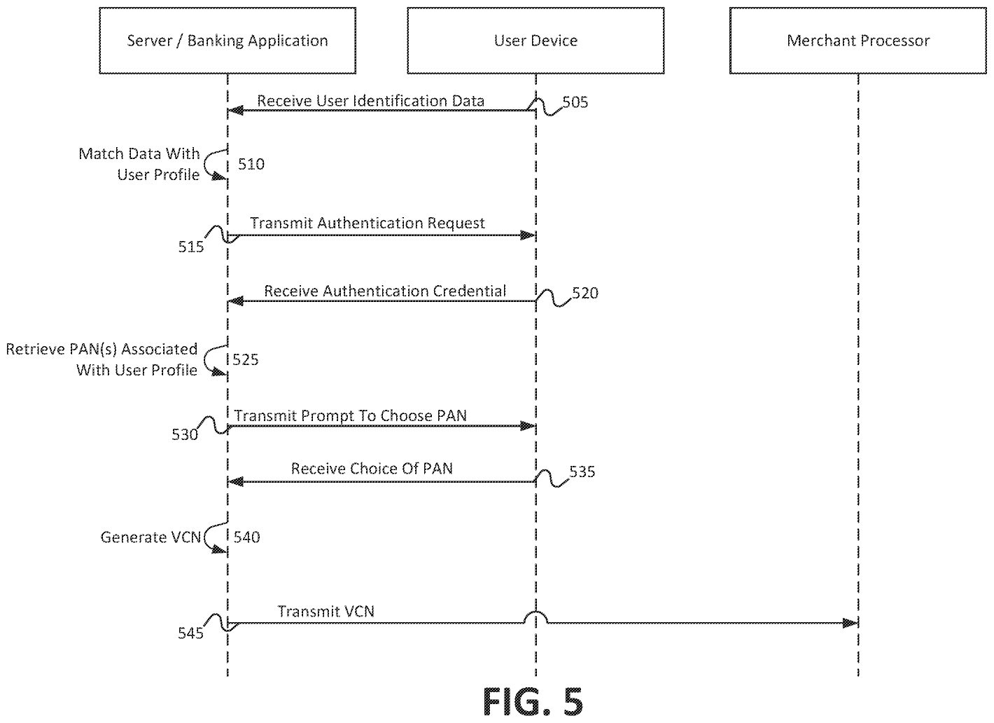

FIG. 5 is a sequence diagram illustrating a method according to an exemplary embodiment. The sequence can include without limitation a server and/or banking application, wherein the banking application can be associated with the server or, in some embodiments, independent of the server. The server itself can be associated with one or more banks and one or more banking applications. The sequence can also include a user device and a merchant processor discussed with further reference to at least FIG. 1.

In action 505, the banking application can receive one or more user identification data from the user device. This data can be received over a wired or wireless network, or over a communication field. The user identification data can include without limitation a name, phone number, email address, card information, unique user identification, or biometric. In some embodiments, more than one user identification data can be received by the banking application over one or more networks or communication fields. Having received the user identification data, the banking application in action 510 can match the data with a user profile. The user profile can be a profile associated with a user or owner of one or more transaction accounts. The transaction accounts can include without limitation a checking, savings, growth, or hybrid accounts. The transaction accounts can also include any account associated with a debit or credit card. Each user profile can be associated with one or more transaction accounts.

In action 515, the banking application can transmit an authentication request to the user device. In response, the banking application in action 520 can receive an authentication credential from the user device. The credential can be received over a network or communication field. The authentication credential can include without limitation a short message service (SMS) one time passcode (OTP), a password, biometric, or unique customer identifier. In some embodiments, the banking application may require multiple authentication credentials transmitted over one or more networks and communication fields. Having received the authentication credentials, the banking application can retrieve one or more PANs associated with the user profile. For example, the banking application may retrieve a two credit-card PANs and one debit card PAN. In a circumstance in which the banking application retrieves only one PAN—e.g., the user has only a debit card-then the banking application will simply generate a VCN based on the single PAN. In most circumstances in which the user profile is associated with several PANs, the banking application in action 530 will transmit a prompt to the user device allowing the user to select with PAN they would prefer to use. The prompt may be generated by the banking application and include the PANs in a selectable list. The prompt can appear on the display of the user device, and the user can click or tap the PAN that they want to use.

In action 535, the banking application can receive the choice of PAN from the user device over a network. Having received the choice of PAN, the banking application in action 540 will generate a VCN associated with the chosen PAN. The VCN and its restrictions are discussed with further reference to FIGS. 4 and 6-10. Having generated the VCN, the banking application can send the VCN directly to the merchant processor associated with the transaction involving the user device. The banking application will not send the VCN to the user device itself to preserve the security and privacy of the user. The VCN can be transmitted over a wireless network.

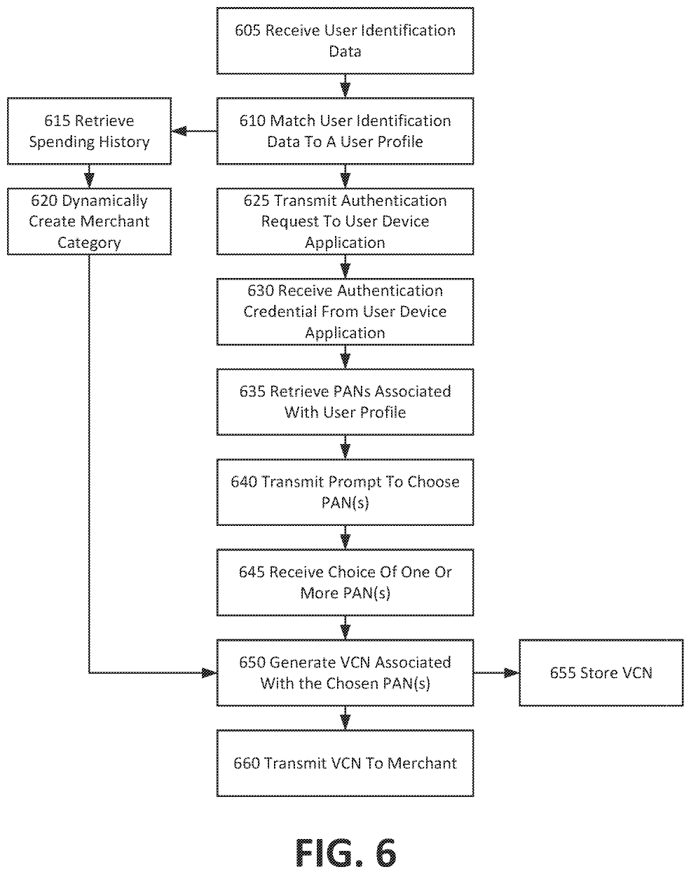

FIG. 6 illustrates a method in which a banking application can dynamically create a merchant category and, based on that dynamically created category, generate a VCN. The banking application may also store the VCN in a data storage unit.

In action 605, the banking application can receive one or more user identification data from the user device. This data can be received over a wired or wireless network, or over a communication field. The user identification data can include without limitation a name, phone number, email address, card information, unique user identification, or biometric. In some embodiments, more than one user identification data can be received by the banking application over one or more networks or communication fields. Having received the user identification data, the banking application in action 610 can match the data with a user profile. The user profile can be a profile associated with a user or owner of one or more transaction accounts. The transaction accounts can include without limitation a checking, savings, growth, or hybrid accounts. The transaction accounts can also include any account associated with a debit or credit card. Each user profile can be associated with one or more transaction accounts.

In action 625, the banking application can transmit an authentication request to the user device. In response, the banking application in action 630 can receive an authentication credential from the user device. The credential can be received over a network or communication field. The authentication credential can include without limitation a SMS OTP, a password, biometric, or unique customer identifier. In some embodiments, the banking application may require multiple authentication credentials transmitted over one or more networks and communication fields. Having received the authentication credentials, the banking application can retrieve one or more PANs associated with the user profile. For example, the banking application may retrieve a two credit-card PANs and one debit card PAN. In a circumstance in which the banking application retrieves only one PAN—e.g., the user has only a debit card-then the banking application will simply generate a VCN based on the single PAN. In most circumstances in which the user profile is associated with several PANs, the banking application in action 640 will transmit a prompt to the user device allowing the user to select with PAN they would prefer to use. The prompt may be generated by the banking application and include the PANs in a selectable list. The prompt can appear on the display of the user device, and the user can click or tap the PAN that they want to use.

In action 645, the banking application can receive the choice of PAN from the user device over a network. Having received the choice of PAN, the banking application in action 650 will generate a VCN associated with the chosen PAN. The VCN and its restrictions are discussed with further reference to FIGS. 4 and 6-10. The restriction on the VCN can include one or more restrictions based on one or more merchant categories. Merchant categories includes types of merchants, including without limitation groceries, bank, restaurants, online merchants, and clothing stores. Restricting the VCN to one or more of these categories ensures that the VCN is less likely to be used for nefarious or fraudulent purposes. For example, a VCN restricted to grocery payments will not be usable at a clothing store. Upon matching the user identification to the user profile, the banking application in action 615 can retrieve a spending history associated with the user profile. Spending history can span any period of time, and it can include without limitation transactions details including dates and times of transactions, merchant names and locations, payment method used (credit and/or debit card, cash, etc.), and the amount spent at the transaction; categories of spending including food, entertainment, transportation, clothing, and other categories commonly used in consumer spending; monthly summaries including an overview of the total amount spent by a user in a specific month or other predetermined time period; location data including information on the physical location of where each transaction took place; and payment history including information on payment due dates, payment amounts, and bills such as rent, utilities, and credit card payments.

Based on this information, the banking application in action 620 can dynamically create a merchant category based on the spending history retrieved. This merchant category will restrict the VCN to being used only at the merchants within the category. When the user requests more VCNs, the banking application can dynamically generate the VCN based on the one or more updated user data associated with the user profile. The dynamic nature of this action ensures that the VCN is always restricted based on the most relevant and updates elements of the user's data. Merchant categories can vary in size. As a nonlimiting example, merchant categories can include groceries, entertainment, travel, leisure, pharmacy, furniture and appliances, rent, utilities, Wi-Fi, and other merchant categories.

Upon being generated, the VCN in action 655 can be stored for long-term storage and/or later use in a database or data storage unit. This action can be performed by the banking application. Having generated the VCN, the banking application inaction 660 can send the VCN directly to the merchant processor associated with the transaction involving the user device. The banking application will not send the VCN to the user device itself to preserve the security and privacy of the user. The VCN can be transmitted over a wireless network.

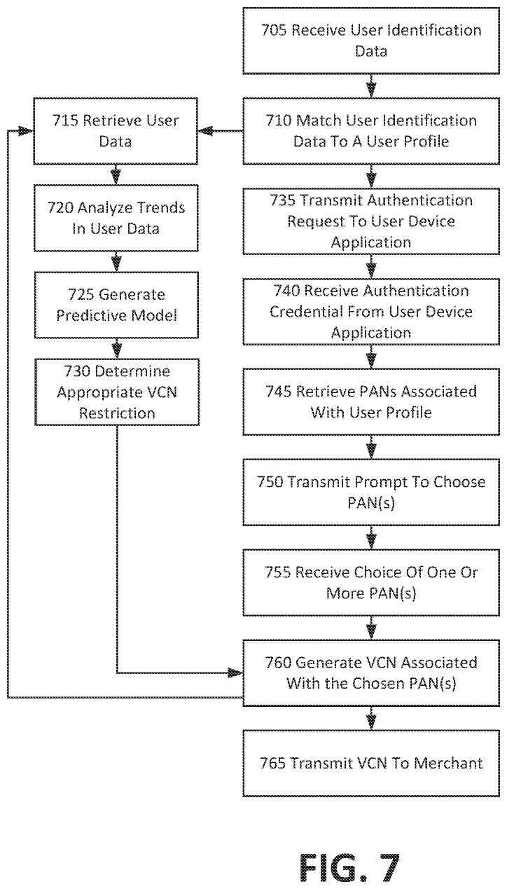

FIG. 7 is a method diagram in which the banking application generates a predictive model and from the model determines an appropriate VCN restriction. The sequence can include without limitation a server and/or banking application, wherein the banking application can be associated with the server or, in some embodiments, independent of the server. The server itself can be associated with one or more banks and one or more banking applications. The sequence can also include a user device and a merchant processor discussed with further reference to at lest FIG. 1.

In action 705, the banking application can receive one or more user identification data from the user device. This data can be received over a wired or wireless network, or over a communication field. The user identification data can include without limitation a name, phone number, email address, card information, unique user identification, or biometric. In some embodiments, more than one user identification data can be received by the banking application over one or more networks or communication fields. Having received the user identification data, the banking application in action 710 can match the data with a user profile. The user profile can be a profile associated with a user or owner of one or more transaction accounts. The transaction accounts can include without limitation a checking, savings, growth, or hybrid accounts. The transaction accounts can also include any account associated with a debit or credit card. Each user profile can be associated with one or more transaction accounts.

In action 735, the banking application can transmit an authentication request to the user device. In response, the banking application in action 740 can receive an authentication credential from the user device. The credential can be received over a network or communication field. The authentication credential can include without limitation a SMS OTP, a password, biometric, or unique customer identifier. In some embodiments, the banking application may require multiple authentication credentials transmitted over one or more networks and communication fields. Having received the authentication credentials, the banking application in action 745 can retrieve one or more PANs associated with the user profile. For example, the banking application may retrieve a two credit-card PANs and one debit card PAN. In a circumstance in which the banking application retrieves only one PAN—e.g., the user has only a debit card-then the banking application will simply generate a VCN based on the single PAN. In most circumstances in which the user profile is associated with several PANs, the banking application in action 750 will transmit a prompt to the user device allowing the user to select with PAN they would prefer to use. The prompt may be generated by the banking application and include the PANs in a selectable list. The prompt can appear on the display of the user device, and the user can click or tap the PAN that they want to use. In action 755, the banking application can receive the choice of PAN from the user device over a network.

Having received the choice of PAN, the banking application in action 760 will generate a VCN associated with the chosen PAN. The VCN and its restrictions are discussed with further reference to FIGS. 4 and 6-10. The restriction on the VCN can include one or more restrictions based on one or more merchant categories. Merchant categories includes types of merchants, including without limitation groceries, bank, restaurants, online merchants, and clothing stores. Restricting the VCN to one or more of these categories ensures that the VCN is less likely to be used for nefarious or fraudulent purposes. For example, a VCN restricted to grocery payments will not be usable at a clothing store.

Upon matching the user identification to the user profile, the banking application in action 715 can retrieve a spending history associated with the user profile. Spending history can span any period of time, and it can include without limitation transactions details including dates and times of transactions, merchant names and locations, payment method used (credit and/or debit card, cash, etc.), and the amount spent at the transaction; categories of spending including food, entertainment, transportation, clothing, and other categories commonly used in consumer spending; monthly summaries including an overview of the total amount spent by a user in a specific month or other predetermined time period; location data including information on the physical location of where each transaction took place; and payment history including information on payment due dates, payment amounts, and bills such as rent, utilities, and credit card payments.

Based on this information, the banking application in action 720 can analyze trends in the user data. This action can include identifying patterns or pattern of change over time regarding the user data. In the context of user spending history, trend analysis involves examining the spending behavior of a particular user or group of users over time to identify recurring patterns, changes in spending habits, and potential insights. Included in the analysis can be the identification of seasonal trends, cyclical trends, trendlines, and outliers. For example, the banking application may notice that spending patterns repeat on a regular basis, such as increased spending during the holiday season or during specific months of the year. As another nonlimiting example, the banking application may notice that there are fluctuations that occur over a period of time, such as alternating periods of high and low spending. As another nonlimiting example, the banking application may notice overall trends in the data that may indicate a general increase or decrease in spending over time. As another nonlimiting example, the banking application may notice that data points that fall outside the expected range of values and may indicate unusual spending behavior.

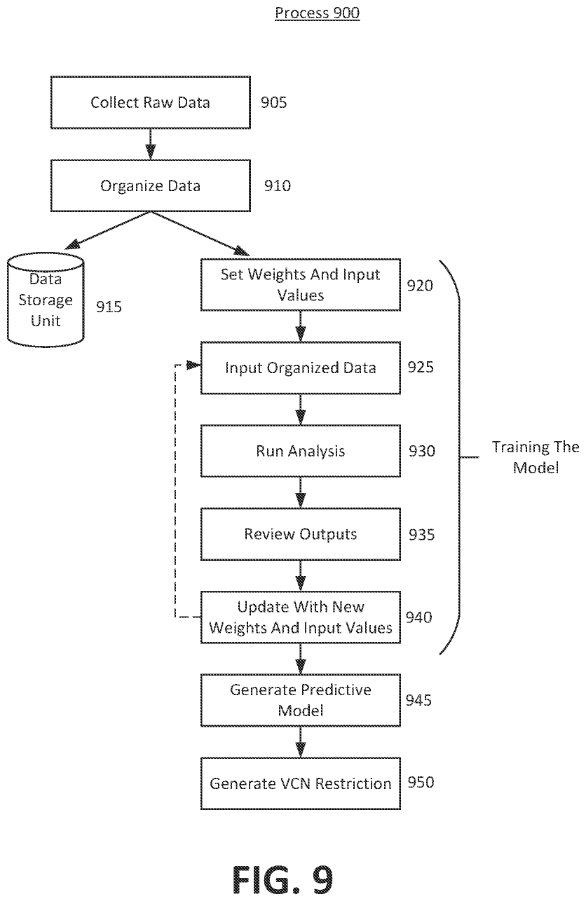

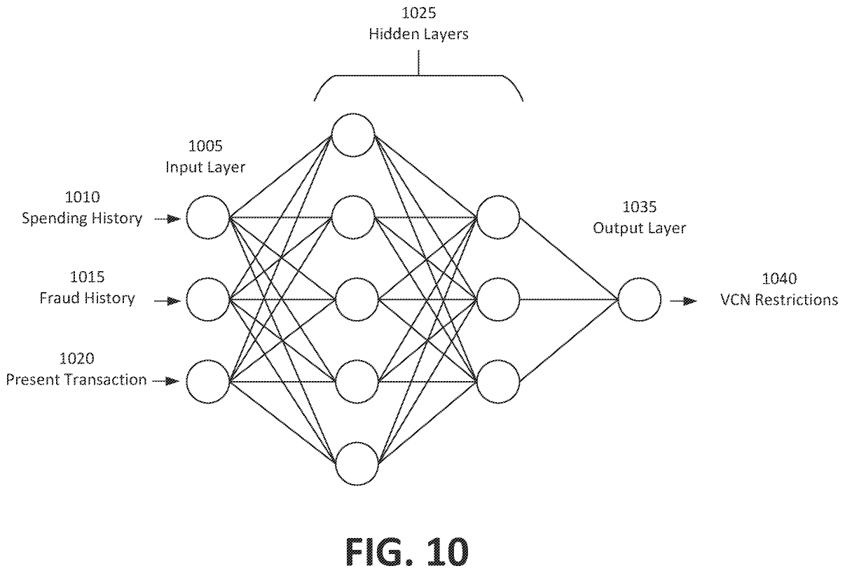

Upon analyzing these one or more trends, the banking application in action 725 can generate a predictive model configured to determine a restriction on a VCN that would be most appropriate for the purposes of deterring fraud while preserving the usefulness of the VCN. The predictive model can comprise a model of one or more future spending habits associated with the user profile anticipated by a predetermined algorithm. The predictive mode can be a machine learning model, a neural network, or some combination therein. The predictive model is discussed with further reference to FIGS. 9 and 10. Having generated the predictive model, the banking application in action 730 can determine an appropriate VCN restriction which may include any of the restrictions discussed herein and with reference to FIG. 4. When the user requests more VCNs, the banking application can dynamically generate the VCN based on the one or more updated user data associated with the user profile. The dynamic nature of this action ensures that the VCN is always restricted based on the most relevant and updates elements of the user's data.

Having generated the VCN, the banking application in action 765 can send the VCN directly to the merchant processor associated with the transaction involving the user device. The banking application will not send the VCN to the user device itself to preserve the security and privacy of the user. The VCN can be transmitted over a wireless network. The VCN can be stored in a database or data storage unit for later use or long term storage.

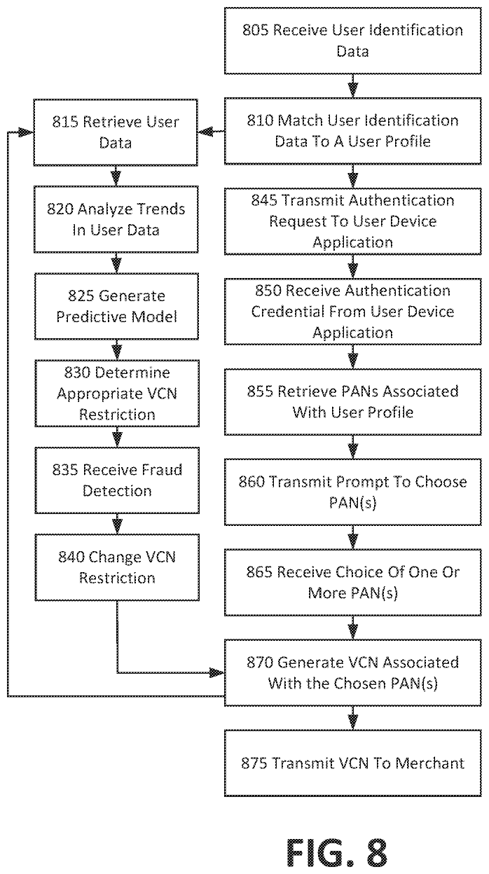

FIG. 8 is a method diagram illustrating a method according to an exemplary embodiment. The sequence can include without limitation a server and/or banking application, wherein the banking application can be associated with the server or, in some embodiments, independent of the server. The server itself can be associated with one or more banks and one or more banking applications. The sequence can also include a user device and a merchant processor discussed with further reference to at least FIG. 1.

In action 805, the banking application can receive one or more user identification data from the user device. This data can be received over a wired or wireless network, or over a communication field. The user identification data can include without limitation a name, phone number, email address, card information, unique user identification, or biometric. In some embodiments, more than one user identification data can be received by the banking application over one or more networks or communication fields. Having received the user identification data, the banking application in action 810 can match the data with a user profile. The user profile can be a profile associated with a user or owner of one or more transaction accounts. The transaction accounts can include without limitation a checking, savings, growth, or hybrid accounts. The transaction accounts can also include any account associated with a debit or credit card. Each user profile can be associated with one or more transaction accounts.

In action 845, the banking application can transmit an authentication request to the user device. In response, the banking application in action 850 can receive an authentication credential from the user device. The credential can be received over a network or communication field. The authentication credential can include without limitation a SMS OTP, a password, biometric, or unique customer identifier. In some embodiments, the banking application may require multiple authentication credentials transmitted over one or more networks and communication fields. Having received the authentication credentials, the banking application in action 855 can retrieve one or more PANs associated with the user profile. For example, the banking application may retrieve a two credit-card PANs and one debit card PAN. In a circumstance in which the banking application retrieves only one PAN—e.g., the user has only a debit card-then the banking application will simply generate a VCN based on the single PAN. In most circumstances in which the user profile is associated with several PANs, the banking application in action 860 will transmit a prompt to the user device allowing the user to select with PAN they would prefer to use. The prompt may be generated by the banking application and include the PANs in a selectable list. The prompt can appear on the display of the user device, and the user can click or tap the PAN that they want to use. In action 865, the banking application can receive the choice of PAN from the user device over a network. Having received the choice of PAN, the banking application in action 870 will generate a VCN associated with the chosen PAN. The VCN and its restrictions are discussed with further reference to FIGS. 4 and 6-10.

The restriction on the VCN can include one or more restrictions based on one or more merchant categories. Merchant categories includes types of merchants, including without limitation groceries, bank, restaurants, online merchants, and clothing stores. Restricting the VCN to one or more of these categories ensures that the VCN is less likely to be used for nefarious or fraudulent purposes. For example, a VCN restricted to grocery payments will not be usable at a clothing store. Upon matching the user identification to the user profile, the banking application in action 815 can retrieve a spending history associated with the user profile. Spending history can span any period of time, and it can include without limitation transactions details including dates and times of transactions, merchant names and locations, payment method used (credit and/or debit card, cash, etc.), and the amount spent at the transaction; categories of spending including food, entertainment, transportation, clothing, and other categories commonly used in consumer spending; monthly summaries including an overview of the total amount spent by a user in a specific month or other predetermined time period; location data including information on the physical location of where each transaction took place; and payment history including information on payment due dates, payment amounts, and bills such as rent, utilities, and credit card payments.

Based on this information, the banking application in action 820 can analyze trends in the user data. This action can include identifying patterns or pattern of change over time regarding the user data. In the context of user spending history, trend analysis involves examining the spending behavior of a particular user or group of users over time to identify recurring patterns, changes in spending habits, and potential insights. Included in the analysis can be the identification of seasonal trends, cyclical trends, trendlines, and outliers. For example, the banking application may notice that spending patterns repeat on a regular basis, such as increased spending during the holiday season or during specific months of the year. As another nonlimiting example, the banking application may notice that there are fluctuations that occur over a period of time, such as alternating periods of high and low spending. As another nonlimiting example, the banking application may notice overall trends in the data that may indicate a general increase or decrease in spending over time. As another nonlimiting example, the banking application may notice that data points that fall outside the expected range of values and may indicate unusual spending behavior. Upon analyzing these one or more trends, the banking application in action 825 can generate a predictive model configured to determine a restriction on a VCN that would be most appropriate for the purposes of deterring fraud while preserving the usefulness of the VCN. The predictive model can comprise a model of one or more future spending habits associated with the user profile anticipated by a predetermined algorithm. The predictive mode can be a machine learning model, a neural network, or some combination therein. The predictive model is discussed with further reference to FIGS. 9 and 10. Having generated the predictive model, the banking application in action 830 can determine an appropriate VCN restriction which may include any of the restrictions discussed herein and with reference to FIG. 4. When the user requests more VCNs, the banking application can dynamically generate the VCN based on the one or more updated user data associated with the user profile. The dynamic nature of this action ensures that the VCN is always restricted based on the most relevant and updates elements of the user's data.

In some circumstances, the banking application may detect fraud in association with the user profile. For example, the banking application in action 835 may receive a notification that a PAN associated with the user account has just been flagged for fraud. The banking application may receive one or more of the notifications. In response to this notification, the banking application in action 840 can change or adjust the VCN restriction. As a nonlimiting example, the banking application may limit to the VCN to even fewer merchant categories or spending limits. Or the VCN may be restricted to a certain location radius. Any of the restrictions mentioned here and in FIG. 4 may be changed or adjusted in response to the fraud detection. Again, the dynamic nature of this action ensures that the VCN is always restricted based on the most relevant and updates elements of the user's data.

Having generated the VCN, the banking application in action 875 can send the VCN directly to the merchant processor associated with the transaction involving the user device. The banking application will not send the VCN to the user device itself to preserve the security and privacy of the user. The VCN can be transmitted over a wireless network.

FIG. 9 is a flowchart illustrating the generation of a predictive model and the calculating of a coverage amount.

The process 900 describes the training process for an exemplary predictive model or neural network suitable for predicting and calculating a coverage amount associated with a lease-applicant. The process can begin with action 905 when raw data is collected. The raw data can include without limitation user spending history. Spending history can span any period of time, and it can include without limitation transactions details including dates and times of transactions, merchant names and locations, payment method used (credit and/or debit card, cash, etc.), and the amount spent at the transaction; categories of spending including food, entertainment, transportation, clothing, and other categories commonly used in consumer spending; monthly summaries including an overview of the total amount spent by a user in a specific month or other predetermined time period; location data including information on the physical location of where each transaction took place; and payment history including information on payment due dates, payment amounts, and bills such as rent, utilities, and credit card payments. The collection of raw data can be performed by a processor or application associated with the user device or server. The raw data can be transmitted over a wired or wireless network. The data may have been previously gathered and stored in a database or data storage unit in which case the processor or application can retrieve the data from the data storage unit.

At action 910, the processor or application can organize the raw data into discernable categories. Merchant categories can vary in size. As a nonlimiting example, merchant categories can include groceries, entertainment, travel, leisure, pharmacy, furniture and appliances, rent, utilities, Wi-Fi, and other merchant categories. The categories can be predetermined by the user or created by the predictive model. At action 915, the organized or raw data can be transmitted to the data storage unit. The data storage unit can be associated with the user device or server. The raw or organized data can be transmitted over a wired network, wireless network, or one or more express buses. The database may comprise a relational database, a non-relational database, or other database implementations, and any combination thereof, including a plurality of relational databases and non-relational databases. In some examples, the database may comprise a desktop database, a mobile database, or an in-memory database. Further, the database may be hosted internally by the server or may be hosted externally of the server, such as by a server, by a cloud-based platform, or in any storage device that is in data communication with the server.

Upon organizing the data into one or categories, the processor or application can proceed with training the predictive model in actions 920 through 940. The training portion can have any number of iterations. The predictive model can comprise one or more neural network described with further reference to FIG. 10.

The training portion can begin with action 920 when the weights and input values are set by the user or by the model itself. Furthermore, the weights can be the predetermined connections between the inputs and the hidden layers described with further reference to FIG. 10. The input values are the values that are fed into the neural network. The input values may be discerned by the different categories created in action 910, although other distinct input values may be discerned. The inputs can include without limitation historical information related to the spending and fraud, and other user data discussed herein. In action 925, the data is inputted in the neural network, and in action 930 the neural network analyzes the data according to the weights and other parameters set by the user. As a nonlimiting, example, the user or banking application may create the stipulation that no VCN will have a spending limit higher than $500. In action 935, the outputs are reviewed. The outputs can include one or more VCN restrictions discussed with further reference to FIG. 4 and elsewhere. In action 940, the predictive model may be updated with new data and parameters. The new data can be collected by the processor in a similar fashion to actions 905 and 910. Though it is not necessary in this exemplary embodiment to retrain the predictive model, the predictive model can be re-trained any number times such that actions 925 through 940 are repeated until a satisfactory output is achieved or some other parameter has been met. As a nonlimiting example, the user may update the inputs with new spending and fraud data. As another nonlimiting example, the user can adjust the weighted relationship between the input layer and the one or more hidden layers of a neural network discussed with further reference to FIG. 10. If a satisfactory output has been recorded, then in action 945 one or more predictive models can be generated. It is understood that the predictive model, once generated, can undergo further training like actions 920 to 945. Having generated the predictive model, in action 950 the model can generate one or more VCN restrictions given the unique input values collected from a user.

FIG. 10 is a diagram illustrating a neural network as an exemplary embodiment for the predictive model.

A neural network is a series of algorithms that can, under predetermined training restrictions, recognize relationships between one or more variables. A neuron in a neural network is a mathematical function that collects and classifies information according to a specific form set by a user. A neural network can be divided into three main components: an input layer, a processing or hidden layer, and an output layer. The input layer comprises data sets chosen to be inserted into the neural network for analysis. The hidden layers include one or more neurons that can classify the inputs according to parameters set by the user. The hidden layers can comprise multiple successive layers, the first layer positioned immediately after the input layer and the last layer positioned immediately before the output layer. The hidden layer immediately after the input layer may be connected to the input layer via a predetermined weight or emphasis. These weights can be assigned according to the modeler's agenda. Alternatively, the model itself can determine the optimal weights between layers such that a predetermined outcome, margin of error, or minimum data point is achieved.

The predictive model can comprise a neural network 1000. The neural network may be integrated into the server, the user device, or some other computer device suitable for neural network analysis. The sever can be associated with a software application such as the banking application. The neural network can include an input layer 1005, one or more hidden layers 1025, and an output layer 1035. Although only a certain number of nodes are depicted in FIG. 10, it is understood that the neural network according to the disclosed embodiments may include less or more nodes in each layer. Additionally, the hidden layers can include more or less layers than what is depicted in FIG. 10. It is also understood that the connections between each layer may be assigned a predetermined weight according to user's manual change or according to some weight value generated by the neural network itself. The input layer may include sets of data gathered from outside sources. The neural network can include without limitation spending history 1010, fraud history 1015, and information about the present transaction 1020. Other inputs not depicted in FIG. 10 can include merchant categories can include groceries, entertainment, travel, leisure, pharmacy, furniture and appliances, rent, utilities, Wi-Fi, and other merchant categories. Upon analyzing the inputs via the one or more hidden layers, the neural network can create one or more document variables 1040. It is understood that one or more neural networks or some combination of neural networks can be trained according to individual users. It is understood that any of the neural networks described herein may be trained or iterated any number of times. In some embodiments, the neural network can be re-trained and/or updated after every recordation of new transaction or fraud notification. In still other embodiments, the neural network can be trained until a sufficient level of accuracy has been reached. The neural networks can be trained to arrive at any number of conclusions, including whether the VCN restrictions are compatible with the present transaction, and what VCN restrictions should be applied.

In some embodiments, the application can analyze biometric using a predictive model including without limitation a recursive neural network (RNN), convolutional neural network (CNN), artificial neural network (ANN), or some other neural network. The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-readable medium can utilize various neural networks, such as CNNs or RNNs, to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

In some aspects, the techniques described herein relate to a system for generating a VCN, the system including: a server including a banking application, wherein the banking application is configured to: receive, from a user device application, one or more user identification data; match the one or more user identification data to a user profile; transmit, to the user device application, an authentication request; receive, from the user device application an authentication credential; retrieve, one or more primary account numbers (PANs) associated with the user profile; transmit, to the user device application, a prompt to choose one or more of the PANs with which to complete a transaction; receive, from the user device application, a choice of one or more PANs; generate a VCN associated with the chosen one or more PANs; and transmit the VCN to a merchant processor.

In some aspects, the techniques described herein relate to a system, wherein the VCN is restricted to one or more merchants.

In some aspects, the techniques described herein relate to a system, wherein the VCN is configured to expire after a predetermined time period.

In some aspects, the techniques described herein relate to a system, wherein the VCN is limited to a predetermined spending limit.

In some aspects, the techniques described herein relate to a system, where in the banking application is further configured to store, upon generating the VCN, the VCN in a data storage unit for later use.

In some aspects, the techniques described herein relate to a system, wherein the VCN is restricted to one or more merchants and one or more merchant categories.

In some aspects, the techniques described herein relate to a system, wherein the banking application is further configured to dynamically create a merchant category based on a spending history associated with the user profile.

In some aspects, the techniques described herein relate to a system, wherein the banking application is further configured to: retrieve, from a database, user location data associated with the user profile; analyze trends in the user location data; and generate a predictive model configured to determine a restriction on the VCN, wherein the predictive model includes a model of one or more future spending habits associated with the user profile anticipated by a predetermined algorithm.

In some aspects, the techniques described herein relate to a system, wherein the banking application is further configured to: retrieve, from a database, spending history data associated with the user profile; analyze trends in the spending history data; and generate a predictive model configured to determine a restriction on the VCN, wherein the predictive model includes a model of one or more future spending habits associated with the user profile anticipated by a predetermined algorithm.

In some aspects, the techniques described herein relate to a system, wherein the banking application is further configured to: retrieve user fraud history data associated with the user profile; analyze trends in the user fraud history data; and generate a predictive model configured to determine a restriction on the VCN wherein the predictive model includes a model of one or more future spending habits associated with the user profile anticipated by a predetermined algorithm.

In some aspects, the techniques described herein relate to a method for generating a VCN, the method including the steps of: receiving, by a banking application associated with a server, one or more user identification data; matching, by the banking application, the one or more user identification data to a user profile; transmitting, by the banking application to a user device application, an authentication request; receiving, by the banking application from the user device application, an authentication credential; retrieving, one or more primary account numbers (PANs) associated with the user profile; transmitting, to the user device application, a prompt to choose one or more of the PANs with which to complete a transaction; receiving, from the user device application, a choice of one or more PANs; generating, by the banking application, a VCN associated with the chosen one or more PANs; and transmitting, by the banking application, the VCN to a merchant processor.

In some aspects, the techniques described herein relate to a method, wherein the VCN is restricted to at least one of a predetermined time period, merchant, geographic location, or price.

In some aspects, the techniques described herein relate to a method, wherein the predetermined restriction is dynamically changed by the banking application in response to one or more spending habits associated with the user profile.

In some aspects, the techniques described herein relate to a method, wherein the method further includes the steps of: retrieve, from a database, spending history data associated with the user profile; analyze trends in the spending history data; and generate a predictive model configured to determine a restriction on the VCN, wherein the restriction is based on a predetermined set of merchant categories.

In some aspects, the techniques described herein relate to a method, wherein the method further includes the steps of: generating, upon receiving a choice of one or more PANs, the VCN, wherein the VCN is bound to the one or more selected PANs.

In some aspects, the techniques described herein relate to a method, wherein the VCN is transmitted from the processor to a merchant processor without notification to the user of the VCN's existence.

In some aspects, the techniques described herein relate to a method, wherein the method further includes the steps of: receiving, by the processor, a fraud detection associated with the VCN; and changing, by the processor in response to the fraud detection, the restrictions associated with the VCN.

In some aspects, the techniques described herein relate to a method, wherein the authentication credential includes a short message service (SMS) one time passcode (OTP), a password, biometric, or unique customer identifier.

In some aspects, the techniques described herein relate to a method, wherein the authentication credential is transmitted over a communication field including near field communication (NFC), radio frequency identification (RFID), or Bluetooth.

In some aspects, the techniques described herein relate to a computer readable non-transitory medium including computer executable instructions that, when executed by a computer hardware arrangement including a processor, causes the computer hardware arrangement to perform procedures including: receiving one or more user identification data; matching the one or more user identification data to a user profile; transmitting to a user device application, an authentication request; receiving, from the user device application, an authentication credential; retrieving, one or more primary account numbers (PANs) associated with the user profile; transmitting, to the user device application, a prompt to choose one or more of the PANs with which to complete a transaction; receiving, from the user device application, a choice of one or more PANs; generating, a VCN associated with the chosen one or more PANs; and transmitting the VCN to a merchant processor.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-readable medium can utilize various neural networks, such as convolutional neural networks (CNNs) or recurrent neural networks (RNNs), to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language).

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A system for generating a virtual card number (VCN), the system comprising:
a server comprising a banking application, wherein the banking application is configured to:
receive, from a user device application, one or more user identification data;
match the one or more user identification data to a user profile;
transmit, to the user device application, an authentication request;
receive, from the user device application an authentication credential;
retrieve, one or more primary account numbers (PANs) associated with the user profile;
transmit, to the user device application, a prompt to choose one or more of the PANs with which to complete a transaction;
receive, from the user device application, a choice of one or more PANs;
generate a virtual card number (VCN) associated with the chosen one or more PANs; and
transmit the VCN to a merchant processor.

2. The system of claim 1, wherein the VCN is restricted to one or more merchants.

3. The system of claim 1, wherein the VCN is configured to expire after a predetermined time period.

4. The system of claim 1, wherein the VCN is limited to a predetermined spending limit.

5. The system of claim 1, where in the banking application is further configured to store, upon generating the VCN, the VCN in a data storage unit for later use.

6. The system of claim 1, wherein the VCN is restricted to one or more merchants and one or more merchant categories.

7. The system of claim 6, wherein the banking application is further configured to dynamically create a merchant category based on a spending history associated with the user profile.

8. The system of claim 1, wherein the banking application is further configured to:
retrieve, from a database, user location data associated with the user profile;
analyze trends in the user location data; and
generate a predictive model configured to determine a restriction on the VCN, wherein the predictive model comprises a model of one or more future spending habits associated with the user profile anticipated by a predetermined algorithm.

9. The system of claim 1, wherein the banking application is further configured to:
retrieve, from a database, spending history data associated with the user profile;
analyze trends in the spending history data; and
generate a predictive model configured to determine a restriction on the VCN, wherein the predictive model comprises a model of one or more future spending habits associated with the user profile anticipated by a predetermined algorithm.

10. The system of claim 1, wherein the banking application is further configured to:
retrieve user fraud history data associated with the user profile;
analyze trends in the user fraud history data; and
generate a predictive model configured to determine a restriction on the VCN wherein the predictive model comprises a model of one or more future spending habits associated with the user profile anticipated by a predetermined algorithm.

11. A method for generating a virtual card number (VCN), the method comprising the steps of:
receiving, by a banking application associated with a server, one or more user identification data;
matching, by the banking application, the one or more user identification data to a user profile;
transmitting, by the banking application to a user device application, an authentication request;
receiving, by the banking application from the user device application, an authentication credential;
retrieving, one or more primary account numbers (PANs) associated with the user profile;
transmitting, to the user device application, a prompt to choose one or more of the PANs with which to complete a transaction;
receiving, from the user device application, a choice of one or more PANs;
generating, by the banking application, a virtual card number (VCN) associated with the chosen one or more PANs; and
transmitting, by the banking application, the VCN to a merchant processor.

12. The method of claim 11, wherein the VCN is restricted to at least one of a predetermined time period, merchant, geographic location, or price.

13. The method of claim 12, wherein the predetermined restriction is dynamically changed by the banking application in response to one or more spending habits associated with the user profile.

14. The method of claim 11, wherein the method further comprises the steps of:
retrieve, from a database, spending history data associated with the user profile;
analyze trends in the spending history data; and
generate a predictive model configured to determine a restriction on the VCN, wherein the restriction is based on a predetermined set of merchant categories.

15. The method of claim 14, wherein the method further comprises the steps of:
generating, upon receiving the choice of one or more PANs, the VCN, wherein the VCN is bound to the one or more selected PANs.

16. The method of claim 15, wherein the VCN is transmitted from the processor to the merchant processor without notification to the user of the VCN's existence.

17. The method of claim 11, wherein the method further comprises the steps of:
receiving, by the processor, a fraud detection associated with the VCN; and
changing, by the processor in response to the fraud detection, one or more restrictions associated with the VCN.

18. The method of claim 11, wherein the authentication credential comprises a short message service (SMS) one time passcode (OTP), a password, biometric, or unique customer identifier.

19. The method of claim 18, wherein the authentication credential is transmitted over a communication field comprising near field communication (NFC), radio frequency identification (RFID), or Bluetooth.

20. A computer readable non-transitory medium comprising computer executable instructions that, when executed by a computer hardware arrangement comprising a processor, causes the computer hardware arrangement to perform procedures comprising:
receiving one or more user identification data;
matching the one or more user identification data to a user profile;
transmitting to a user device application, an authentication request;
receiving, from the user device application, an authentication credential;
retrieving, one or more primary account numbers (PANs) associated with the user profile;
transmitting, to the user device application, a prompt to choose one or more of the PANs with which to complete a transaction;
receiving, from the user device application, a choice of one or more PANs;
generating, a virtual card number (VCN) associated with the chosen one or more PANs; and
transmitting the VCN to a merchant processor.
